(19) United States
(12) Patent Application Publication
(10) Pub. No.: US 2024/0007465 A1
(43) Pub. Date: Jan. 4, 2024

(54) CONTROLLING ACCESS TO COMPONENTS OF A SOFTWARE-DEFINED DATA CENTER IN A HYBRID ENVIRONMENT

(71) Applicant: VMware, Inc., Palo Alto, CA (US)

(72) Inventors: Prateek GUPTA, San Francisco, CA (US); Fnu YASHU, Sunnyvale, CA (US); John E. BREZAK, Camano Island, WA (US); Wei DU, Santa Clara, CA (US); Margarita Cabangangan MIRANDA, Oakland, CA (US)

(21) Appl. No.: 17/856,862

(22) Filed: Jul. 1, 2022

(51) Int. Cl. H04L 9/40

(52) U.S. Cl. CPC H04L 63/0853; H04L 63/102

(57) ABSTRACT

A method of controlling access to components of an SDDC in a hybrid environment, the hybrid environment including a cloud platform from which cloud services are delivered to the SDDC through agents deployed on an agent platform appliance, includes the steps of: transmitting to a first component of the SDDC, a request to create a first account for accessing the first component of the SDDC by a first agent, which is one of the agents deployed on the agent platform appliance; in response to the first agent requesting access to the first component of the SDDC, transmitting to the first component of the SDDC, credentials associated with the first account and a request for a first authentication token that authorizes the access to the first component of the SDDC; and upon receiving the first authentication token from the first component of the SDDC, transmitting the first authentication token to the first agent.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

It has become common for multiple SDDCs to be deployed across multiple clusters of hosts. Each cluster is a group of hosts that are managed together by the management software to provide cluster-level functions, such as load balancing across the cluster through VM migration between the hosts, distributed power management, dynamic VM placement according to affinity and anti-affinity rules, and high availability (HA). The management software also manages a shared storage device to provision storage resources for the cluster from the shared storage device, and a software-defined network, through which the VMs communicate with each other. For some customers, their SDDCs are deployed across different geographical regions, and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not have to carry out management operations on the SDDC, such as configuration, upgrading, and patching, and the availability of the SDDCs is provided according to the service level agreement of the subscription.

With a large number of SDDCs, monitoring and performing operations on the SDDCs through interfaces, e.g., application programming interfaces (APIs), provided by the management software, and managing the lifecycle of the management software, have proven to be challenging. Conventional techniques for managing the SDDCs and the management software of the SDDCs are not practicable when there is a large number of SDDCs, especially when they are spread out across multiple geographical locations and in a hybrid manner.

### SUMMARY

One or more embodiments provide a cloud platform from which various services, referred to herein as “cloud services” are delivered to the SDDCs through agents of the cloud services that are running in an appliance (referred to herein as an “agent platform appliance”). The cloud platform is a computing platform that hosts containers or virtual machines corresponding to the cloud services that are delivered from the cloud platform. The agent platform appliance is deployed in the same customer environment, e.g., a private data center, as the management appliances of the SDDCs. In one embodiment, the cloud platform is provisioned in a public cloud and the agent platform appliance is provisioned as a virtual machine in the customer environment, and the two communicate over a public network, such as the Internet. In addition, the agent platform appliance and the management appliances communicate with each other over a private physical network, e.g., a local area network. Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the management software of the SDDCs is carried out through the agent platform appliance, for example, through respective agents of the cloud services that are deployed on the agent platform appliance.

In one embodiment, a method of controlling access to components of an SDDC in a hybrid environment is provided, the hybrid environment including a cloud platform from which cloud services are delivered to the SDDC through agents deployed on an agent platform appliance which is connected to a management network of the SDDC. The method includes the steps of: transmitting to a first component of the SDDC, a request to create a first account for accessing the first component of the SDDC by a first agent, which is one of the agents deployed on the agent platform appliance; in response to the first agent requesting access to the first component of the SDDC, transmitting to the first component of the SDDC, credentials associated with the first account and a request for a first authentication token that authorizes the access to the first component of the SDDC; and upon receiving the first authentication token from the first component of the SDDC, transmitting the first authentication token to the first agent. The first agent transmits to the first component of the SDDC, the first authentication token along with a first command that instructs the first component of the SDDC to perform an operation.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a computer system in which embodiments may be implemented.

FIG. 2 is a block diagram illustrating an example of privilege mappings for accessing an SDDC component.

FIG. 3 is a block diagram illustrating an example of different accounts that have been set up in an SDDC component.

FIG. 4 is a block diagram illustrating an example of privilege mappings for accessing cloud services of a cloud platform.

FIG. 5 is a flow diagram of steps performed by a discovery agent of the agent platform appliance to carry out a method of creating privilege mappings illustrated in FIGS. 2 and 4.

FIG. 6 is a flow diagram of steps performed by the discovery agent and an SDDC component to carry out a method of creating accounts in the SDDC component, according to an embodiment.

FIG. 7 is a flow diagram of steps performed by a cloud service agent of the agent platform appliance and the discovery agent to carry out a method of issuing a command to perform an operation to an SDDC component, according to an embodiment

FIG. 8 is a flow diagram of steps performed by the discovery agent and an SDDC component to carry out a method of acquiring a token for authenticating with the SDDC component, according to an embodiment.

FIG. 9 is a flow diagram of steps performed by a cloud service agent of the agent platform appliance and the discovery agent to carry out a method of making an API call to a cloud service, according to an embodiment.

FIG. 10 is a flow diagram of steps performed by the discovery agent and a remote server to carry out a method of issuing a token for authenticating with a cloud service, according to an embodiment.

### DETAILED DESCRIPTION

Techniques for connecting a tenant's SDDCs to a cloud platform are described. According to embodiments, an agent platform appliance is deployed in a customer environment of the tenant, the customer environment including one or more SDDCs with management software for the SDDCs executing therein. The agent platform appliance is connected to the same management network as management appliances on which the management software is deployed. To connect the tenant's SDDCs to cloud services of the cloud platform, agents are deployed on the agent platform appliance. The agents perform various functionalities, including transmitting commands to the management software of the SDDCs, acquiring authentication tokens for authenticating with the management software, and acquiring access tokens for authenticating with the cloud services.

Communications between the agent platform appliance and the SDDCs are authenticated using tokens (hereinafter referred to as “authentication tokens”). Each authentication token is scoped to a “role,” which is associated with privileges for accessing a component of each of the tenant's SDDCs. Accordingly, an agent of the agent platform appliance that possesses an authentication token is only permitted to issue commands that are within a defined set of privileges. Furthermore, communications between the agent platform appliance and the cloud platform are authenticated using tokens (hereinafter referred to as “access tokens”). Each access token authorizes accessing one or more of the cloud services and, for each cloud service that the access token authorizes access to, privileges defined by the cloud services for such access such as read and/or write access. Accordingly, an agent of the agent platform appliance that possesses an access token is only permitted to perform actions that fall within specified privileges, and with one or more specified cloud services. One of the agents of the agent platform appliance manages, for other agents executing therein, which authentication and access tokens the other agents are authorized to use. Such management improves security by preventing these agents from performing actions that are outside the scopes of the roles that are assigned to them.

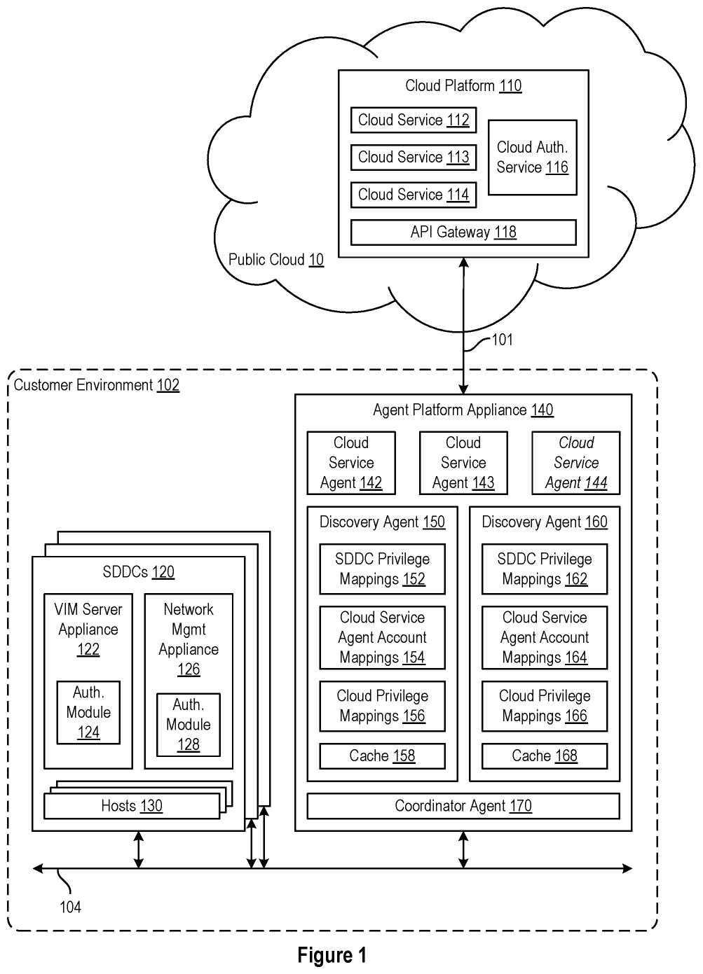

FIG. 1 is a block diagram of a computer system in which embodiments may be implemented. The computer system includes a multi-tenant cloud platform 110 deployed in a public cloud 10, and a customer environment 102 in which SDDCs 120 of a particular tenant are deployed. Communications between cloud platform 110 and SDDCs 120 are carried out via an agent platform appliance 140 of customer environment 102. Communications between cloud platform 110 and agent platform appliance 140 are carried out over a public network 101 such as the Internet.

Each of SDDCs 120 includes hosts 130, hosts 130 being constructed on server grade hardware platforms (not shown) such as x86 architecture platforms. Hosts 130 include conventional components of computing devices (not shown), such as one or more central processing units (CPUs), memory such as random-access memory (RAM), local storage such as one or more magnetic drives or solid-state drives (SSDs) and/or a host bus adapter for connection to a storage area network, and one or more network interface cards (NICs). The NIC(s) enable hosts 130 to communicate with each other and with other devices over a management network 104. Hosts 130 include software platforms including hypervisors (not shown), which are virtualization software layers that support VM execution spaces (not shown) within which VMs are concurrently instantiated and executed. Each of SDDCs 120 also includes additional hardware devices (not shown) such as shared storage and networking devices.

Each of SDDCs 120 includes a VIM server appliance 122, a network management appliance 126, and other SDDC components (not shown) each running various management software. VIM server appliance 122 logically groups hosts 130 into a cluster to perform cluster-level tasks such as provisioning and managing VMs and migrating VMs from one host 130 to another. One example of VIM server appliance 122 is a VMware vCenter Server® appliance from VMware, Inc. Network management appliance 126 provisions virtual networking resources for VMs executing on hosts 130. An example of network management appliance 126 is a VMware NSX® appliance from VMware, Inc.

VIM server appliance 122, network management appliance 126, and other SDDC components communicate via management network 104, and the various management software running thereon are referred to collectively herein as “management software.” Management network 104 is distinguishable from public network 101 in that it is a private network, e.g., a local area network or a sub-net, and is partitioned from public network 101 through a firewall. In some embodiments, each of the SDDC components including VIM server appliance 122 and network management appliance 126 is a VM instantiated on one or more of hosts 130. In other embodiments, each of the SDDC components may be implemented as a physical host having the conventional hardware platform described above with respect to hosts 130.

VIM server appliance 122 includes an authentication module 124, which communicates with an authentication server (not shown) to authenticate requests for access. When it is able to authenticate such requests, authentication module 124 issues role-based authentication tokens such as Security Assertions Markup Language (SAML) tokens. Each authentication token allows a party possessing the token to access VIM server appliance 122 to perform an operation on VIM server appliance 122 that is associated with the issued token. Network management appliance 126 similarly includes an authentication module 128, which communicates with an authentication server (not shown) to issue role-based authentication tokens for requesting parties. For security purposes, authentication tokens each have a specified time-to-live (TTL), after which the tokens expire.

Cloud platform 110 is provisioned in public cloud 10, and public cloud 10 is operated by a cloud computing service provider from a plurality of physical host computers (not shown). Cloud platform 110 includes cloud services such as cloud services 112, 113, and 114, a cloud authentication service 116, and an API gateway 118. The cloud services include an SDDC configuration service, an SDDC upgrade service, an SDDC monitoring service, an SDDC inventory service, and a message broker service.

Cloud authentication service 116 enables authentication with the cloud services. To enable such authentication, cloud authentication service 116 issues access tokens such as JavaScript Object Notation (JSON) web tokens (JWTs). Each access token allows a requesting party to communicate with a cloud service through API gateway 118, as discussed below. It should be noted that although cloud authentication service 116 is illustrated as being within cloud platform 110, cloud authentication service 116 may run on a virtual or physical server that is not part of cloud platform 110. For security purposes, access tokens each have a specified TTL, after which the tokens expire.

Agent platform appliance 140 is connected to management network 104 such that agent platform appliance 140 and SDDCs 120 are on the same side of a firewall (not shown) of customer environment 102. As a result, communications between agent platform appliance 140 and SDDCs 120 are secure and protected from attacks originating from outside customer environment 102 such as snooping attacks. In some embodiments, agent platform appliance 140 is a VM instantiated on a physical host having the conventional hardware platform described above with respect to hosts 130, including a CPU(s) configured to execute instructions such as executable instructions that perform one or more operations described herein and including memory in which such executable instructions are stored. In other embodiments, agent platform appliance 140 may be implemented as such a physical host.

On agent platform appliance 140, various agents are deployed, including cloud service agents 142, 143, and 144, discovery agents 150 and 160, and a coordinator agent 170. The agents on agent platform appliance 140 communicate with each other, e.g., through hypertext transfer protocol (HTTP) APIs. The agents on agent platform appliance 140 also communicate with SDDCs 120 and cloud platform 110, as discussed further below. Coordinator agent 170 deploys the agents on agent platform appliance 140, managing the lifecycle and orchestration thereof.

Some of the agents, referred to herein as “persistent agents,” execute in agent platform appliance 140 indefinitely once deployed. Other agents, referred to herein as “on-demand agents,” only execute in agent platform appliance 140 for limited times. Once deployed, the on-demand agents download executable scripts from which the on-demand agents issue commands to SDDCs 120 to execute workloads. Upon completion of the workloads, coordinator agent 170 deletes the on-demand agents. As illustrated in FIG. 1, cloud service agents 142 and 143 are persistent agents, and cloud service agent 144 is an on-demand agent.

Cloud service agents 142, 143, and 144, referred to collectively as “the cloud service agents,” correspond to cloud services 112, 113, and 114, respectively. The cloud service agents issue commands to the management software of SDDCs 120 and report results of operations to respective cloud services through APIs of the cloud services. The cloud service agents make API calls via API gateway 118 to respective cloud services, e.g., to report results of operations performed by the management software of SDDCs 120.

Discovery agents 150 and 160 are deployed on agent platform appliance 140 to manage communication with respective management software of SDDCs 120 and cloud services. Discovery agent 150 is deployed to manage communications with VIM server appliance 122 for all of SDDCs 120, and discovery agent 160 is deployed to manage communications with network management appliance 126 for all of SDDCs 120. There are also additional discovery agents (not shown) corresponding to the other SDDC components of SDDCs 120.

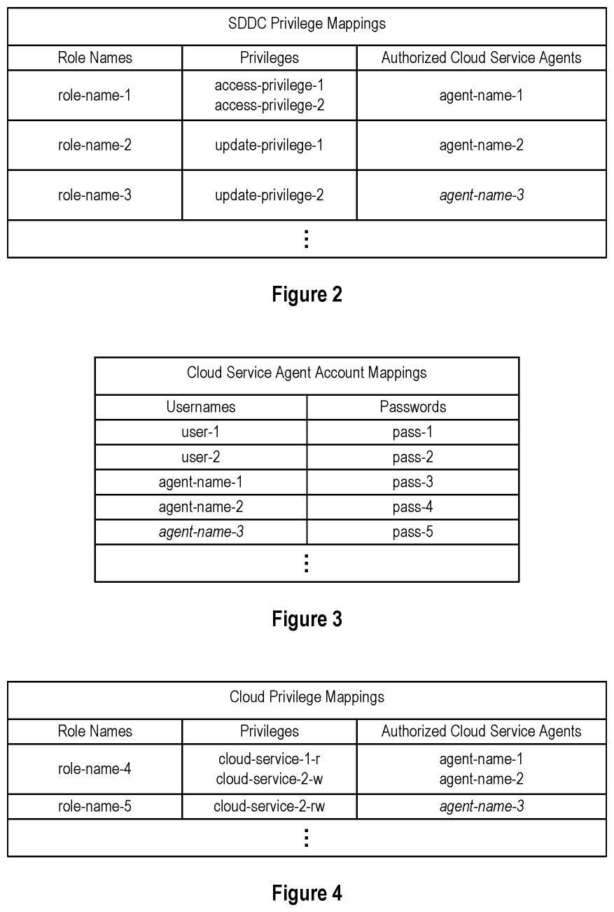

Discovery agents 150 and 160 store admin credentials of respective SDDC components for logging in to the respective SDDC components to perform administrative actions, as discussed further below. Discovery agents 150 and 160 also communicate with respective SDDC components to acquire authentication tokens for the cloud service agents. Discovery agents 150 and 160 maintain sets of SDDC privilege mappings 152 and 162, respectively. SDDC privilege mappings indicate which “roles” the cloud service agents are authorized for and what privileges are associated with these roles, as discussed further below in conjunction with FIG. 2.

Using the admin credentials of respective SDDC components, discovery agents 150 and 160 create accounts in the respective SDDC components, referred to herein as “cloud service agent accounts.” Discovery agents 150 and 160 store credentials for the cloud service agent accounts in cloud service agent account mappings 154 and 164, respectively, as discussed further below in conjunction with FIG. 3. Later, when a particular cloud service agent requests an authentication token to access an SDDC component, the discovery agent associated with that SDDC component verifies from its SDDC privilege mappings that the cloud service agent is authorized for a requested role associated with the authentication token. Upon this verification, the discovery agent logs in to the SDDC component using the credentials that have been set up for the account of the cloud service agent. In response, the SDDC component issues an authentication token that is scoped for the role associated with this account.

Discovery agents 150 and 160 are also configured to acquire access tokens from cloud authentication service 116. Discovery agents 150 and 160 acquire access tokens, for example, to enable the cloud service agents to directly report results of operations performed by respective management software, via APIs of the cloud services. Discovery agents 150 and 160, when deployed, are issued certificates that are associated with a private key and a public key. To authenticate with cloud authentication service 116, the discovery agents transmit a challenge phrase that is signed with the private key, and in response, cloud authentication service 116 decrypts the payload using the public key. If the decrypted payload matches the challenge phrase, cloud authentication service 116 issues the access token, which enables one of the cloud service agents to access one or more cloud services, as discussed further below.

Before providing access tokens to the cloud service agents, discovery agents 150 and 160 verify that the cloud service agents are authorized for the access tokens being requested. To perform this verification, discovery agents 150 and 160 maintain sets of cloud privilege mappings 156 and 166, respectively. Cloud privilege mappings indicate which cloud services the cloud service agents are authorized to communicate with and specified privileges for such communication, as discussed further below in conjunction with FIG. 4. Additionally, as previously mentioned, authentication and access tokens each have a specified TTL. Accordingly, discovery agents 150 and 160 maintain caches 158 and 168, respectively, for storing active authentication and access tokens. Upon the specified TTL elapsing for such tokens, discovery agents 150 and 160 delete the tokens from their respective caches.

In one embodiment, each of the cloud services is a microservice that is implemented as one or more container images executed on a virtual infrastructure of public cloud 10. Similarly, each of the agents deployed on agent platform appliance 140 is a microservice that is implemented as one or more container images executing in agent platform appliance 140.

FIG. 2 is a block diagram illustrating an example of SDDC privilege mappings such as SDDC privilege mappings 152. For explanatory purposes, FIG. 2 will be discussed with respect to discovery agent 150. SDDC privilege mappings 152 include a plurality of roles, each of the roles corresponding to one or more privileges and one or more authorized cloud service agents. For example, some privileges may allow for the access of specified data or metadata of VIM server appliance 122, while other privileges may allow for the updating of specified data or metadata of VIM server appliance 122 such as for the creation or deletion of a VM by VIM server appliance 122.

A first role named “role-name-1” is associated with two privileges: an “access-privilege-1” and an “access-privilege-2.” Each of the two privileges associated with role-name-1 authorizes the retrieval of specified data or metadata. As depicted, “agent-name-1” is assigned role-name-1. Accordingly, if agent-name-1 requests an authentication token from discovery agent 150 for role-name-1, discovery agent 150 acquires the authentication token from VIM server appliance 122. The authentication token that is acquired is scoped by VIM server appliance 122 to permit retrieval of the data or metadata specified by access-privilege-1 and access-privilege-2.

A second role named “role-name-2” is associated with one privilege: an “update-privilege-1.” Update-privilege-1 authorizes the updating of specified data or metadata. As depicted, one agent named “agent-name-2” is assigned role-name-2. Accordingly, if agent-name-2 requests an authentication token from discovery agent 150 for role-name-2, discovery agent 150 acquires the authentication token from VIM server appliance 122. The authentication token that is acquired is scoped by VIM server appliance 122 to permit the updating of the data or metadata specified by update-privilege-1.

A third role named “role-name-3” is associated with one privilege: an “update-privilege-2.” Update-privilege-2 authorizes the updating of specified data or metadata. As depicted, one agent named “agent-name-3,” which is an on-demand agent, is assigned role-name-3. Accordingly, if agent-name-3 requests an authentication token from discovery agent 150 for role-name-3, discovery agent 150 acquires the authentication token from VIM server appliance 122. The authentication token that is acquired is scoped by VIM server appliance 122 to permit the updating of the data or metadata specified by update-privilege-2.

If one of the cloud service agents not identified as being authorized for a particular authentication token requests the authentication token from discovery agent 150, the request will be rejected. In addition, if one of the cloud service agents attempts to retrieve or update data or metadata of VIM server appliance 122 that is outside the scope of an authentication token, the attempt will fail.

FIG. 3 is a block diagram illustrating an example of cloud service agent account mappings such as cloud service agent account mappings 154. For explanatory purposes, FIG. 3 will be discussed with respect to discovery agent 150. Cloud service agent account mappings 154 include a plurality of usernames and passwords of accounts with VIM server appliance 122. Some of such accounts are “user” accounts, i.e., accounts that are used by physical users for issuing commands to VIM server appliance 122 without the use of the cloud service agents. Other of such accounts are cloud service agent accounts that each corresponds to one of the cloud service agents.

The first two accounts are defined by the usernames “user-1” and “user-2,” respectively, and the passwords “pass-1” and “pass-2,” respectively. These two accounts are user accounts used for issuing commands to VIM server appliance 122. The third account is a cloud service agent account defined by the username “agent-name-1” and the password “pass-3.” Accordingly, to acquire an authentication token for agent-name-1, discovery agent 150 transmits to VIM server appliance 122, the credentials “agent-name-1” and “pass-3” along with a request for an authentication token for a role that agent-name-1 is authorized for.

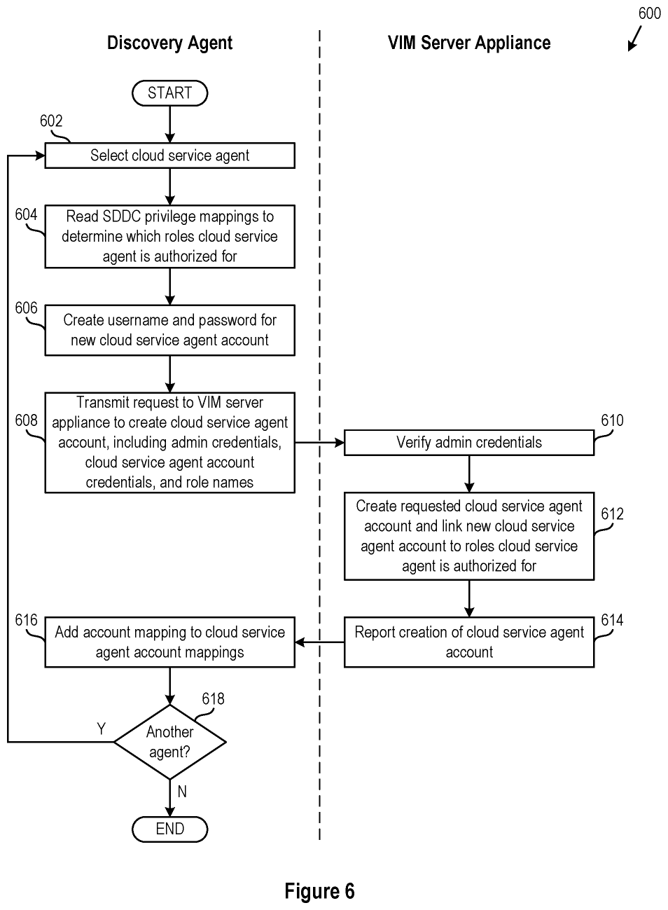

Similarly, the fourth and fifth accounts are cloud service agent accounts defined by the usernames “agent-name-2” and “agent-name-3,” respectively, and the passwords “pass-4” and “pass-5,” respectively. Accordingly, to acquire an authentication token for agent-name-2, discovery agent 150 provides the credentials “agent-name-2” and “pass-4,” and to acquire an authentication token for agent-name-3, discovery agent 150 provides the credentials “agent-name-3” and “pass-5.” Agent-name-3 is a name of an on-demand agent, and the cloud service agent account defined by the username agent-name-3 is thus an “ephemeral account,” as discussed further below in conjunction with FIG. 6.

FIG. 4 is a block diagram illustrating an example of cloud privilege mappings such as cloud privilege mappings 156. For explanatory purposes, FIG. 4 will be discussed with respect to discovery agent 150. Cloud privilege mappings 156 include a plurality of roles, each of the roles corresponding to one or more privileges and one or more authorized cloud service agents. For example, some privileges may allow for reading data or metadata received from a cloud service, some privileges may allow for writing data or metadata to be transmitted to a cloud service, and some privileges may allow for both reading and writing.

A first role named “role-name-4” is associated with two privileges: a “cloud-service-1-r” privilege and a “cloud-service-2-w” privilege. Cloud-service-1-r authorizes reading data from a first cloud service “cloud service 1,” while cloud-service-2-w authorizes writing data to a second cloud service “cloud service 2.” As depicted, “agent-name-1” and “agent-name-2” are each assigned role-name-4. Accordingly, if agent-name-1 or agent-name-2 requests an access token from discovery agent 150 for role-name-4, discovery agent 150 acquires the access token from cloud authentication service 116. The access token that is acquired is scoped by cloud-service-1 and cloud-service-2 to permit the specified accesses.

A second role named “role-name-5” is associated with one privilege: a “cloud-service-2-rw” privilege. Cloud-service-2-rw authorizes reading data from and writing data to cloud service 2. As depicted, “agent-name-3,” which is an on-demand agent, is assigned role-name-5. Accordingly, if agent-name-3 requests an access token from discovery agent 150 for role-name-5, discovery agent 150 acquires the access token from cloud authentication service 116. The access token that is acquired is scoped by cloud-service-2 to permit the specified access.

If one of the cloud service agents not identified as being authorized for a particular access token requests the access token from discovery agent 150, the request will be rejected. In addition, if one of the cloud service agents attempts to access a cloud service that does not correspond to an access token provided by discovery agent 150 or attempts to perform an action that does not fall within the privileges of the access token, the attempt will fail.

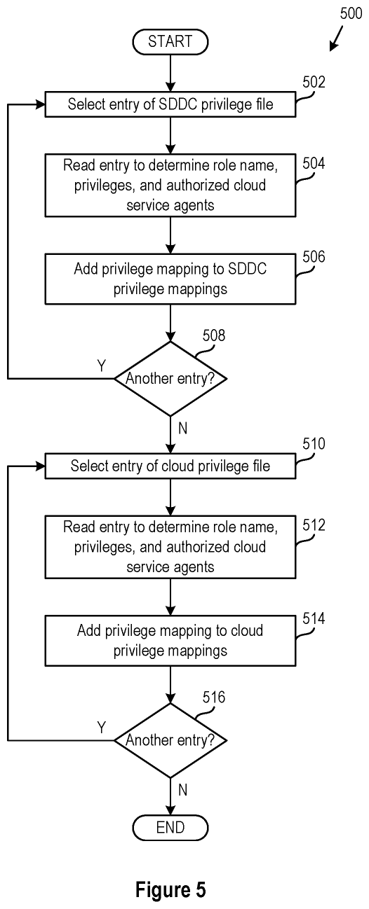

FIG. 5 is a flow diagram of steps performed by a discovery agent of agent platform appliance 140 to carry out a method 500 of creating SDDC privilege mappings and cloud privilege mappings. For explanatory purposes, each of the flow diagrams discussed below, including FIG. 5, will be discussed with reference to cloud service 112, discovery agent 150 and VIM server appliance 122. However, it should be understood that such flow diagrams are also applicable to other cloud services of cloud platform 110, other discovery agents of agent platform appliance 140, and other SDDC components of SDDCs 120.

Before method 500, discovery agent 150 is provided an “SDDC privilege file” and a “cloud privilege file,” which are files such as JSON files. The SDDC privilege file defines roles for accessing VIM server appliance 122, including information such as privileges and authorized cloud service agents for particular roles. Similarly, the cloud privilege file defines roles for accessing cloud service 122, including information such as privileges and authorized cloud service agents. The SDDC and cloud privilege files may be created by the tenant of SDDCs 120.

At step 502, discovery agent 150 selects an entry of the SDDC privilege file. At step 504, discovery agent 150 reads the entry to determine the role name and the associated privileges and authorized cloud service agents. At step 506, discovery agent 150 creates a new mapping, associating the determined role name with the determined privileges and authorized cloud service agents, and adds the new mapping to SDDC privilege mappings 152. At step 508, if there is another entry of the SDDC privilege file, method 500 returns to step 502, and discovery agent 150 selects another entry. Otherwise, method 500 moves to step 510.

At step 510, discovery agent 150 selects an entry of the cloud privilege file. At step 512, discovery agent 150 reads the entry to determine the role name and the associated privileges and authorized cloud service agents. At step 514, discovery agent 150 creates a new mapping, associating the determined role name with the determined privileges and authorized cloud service agents, and adds the new mapping to cloud privilege mappings 156. At step 516, if there is another entry of the cloud privilege file, method 500 returns to step 510, and discovery agent 150 selects another entry. Otherwise, method 500 ends.

After method 500, the tenant of SDDCs 120 may update the SDDC and cloud privilege files such as when deploying a new on-demand service agent. Accordingly, steps 504 and 506 may be repeated to read new entries of the SDDC privilege file and create new mappings for SDDC privilege mappings 152. Similarly, steps 512 and 514 may be repeated to read new entries of the cloud privilege file and create new mappings for cloud privilege mappings 156.

FIG. 6 is a flow diagram of steps performed by discovery agent 150 and VIM server appliance 122 to carry out a method 600 of creating cloud service agent accounts in VIM server appliance 122 for one of SDDCs 120, according to an embodiment. Method 600 is performed after the creation of SDDC privilege mappings 152 in steps 502-508 of method 500 of FIG. 5.

At step 602, discovery agent 150 selects one of the cloud service agents of agent platform appliance 140. At step 604, discovery agent 150 reads SDDC privilege mappings 152 to determine which roles the selected cloud service agent is authorized for. The selected cloud service agent may be authorized for only a single role or may be authorized for a plurality of roles. At step 606, discovery agent 150 creates a username and password for a new cloud service agent account to be created for the selected cloud service agent.

At step 608, discovery agent 150 transmits a request to VIM server appliance 122 to create a cloud service agent account. The request includes admin credentials of VIM server appliance 122 such as a username and password authenticating the request as being from discovery agent 150, which has administrative privileges such as to create cloud service agent accounts and to update the passwords of such cloud service agent accounts, as discussed further below. The request also includes the cloud service agent account credentials created at step 606 and role names of the roles that the selected cloud service agent is authorized for.

At step 610, VIM server appliance 122 verities the admin credentials to determine that the request is from discovery agent 150. At step 612, VIM server appliance 122 creates the requested cloud service agent account with the username and password created at step 606. VIM server appliance 122 further links the new cloud service agent account to roles that the selected cloud service agent is authorized for. At step 614, VIM server appliance 122 reports, to discovery agent 150, the creation of the cloud service agent account.

At step 616, discovery agent 150 creates a new cloud service agent account mapping, including the username and password created at step 606, and adds the new mapping to cloud service agent account mappings 154. At step 618, if there is another one of the cloud service agents to create a cloud service agent account for, method 600 returns to step 602, and discovery agent 150 selects another one of the cloud service agents. Otherwise, method 600 ends.

Method 600 may be repeated for each of SDDCs 120 to create cloud service agent accounts therefor. Furthermore, discovery agent 150 periodically transmits to VIM server appliance 122, requests to update the passwords associated with each of the cloud service agent accounts to improve the security of the accounts. The requests include amin credentials of VIM server appliance 122. Discovery agent 150 generates updated passwords and updates cloud service agent account mappings 154 accordingly. Additionally, for on-demand agents, the cloud service agent accounts are ephemeral. An ephemeral cloud service agent account may have a specified TTL, and upon the specified TTL elapsing, discovery agent 150 transmits a request to VIM server appliance 122 to delete the account. Discovery agent 150 may also transmit the request to VIM server appliance 122 to delete the account upon the deletion of the on-demand agent by coordinator agent 170. Discovery agent 150 then removes the ephemeral accounts from cloud service agent account mappings 154.

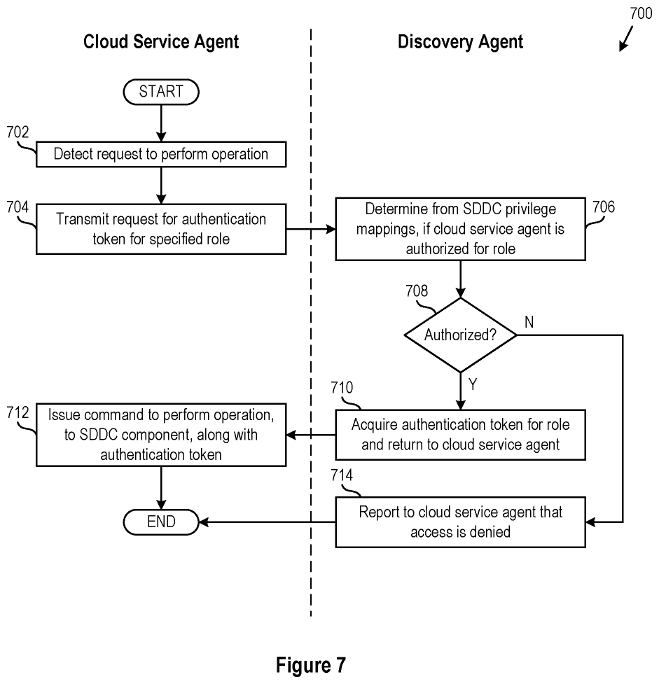

FIG. 7 is a flow diagram of steps performed by a cloud service agent of agent platform appliance 140 and discovery agent 150 to carry out a method 700 of issuing a command to perform an operation to VIM server appliance 122, according to an embodiment. At step 702, the cloud service agent detects a request to access VIM server appliance 122, from cloud service 112. The requested access may be, e.g., to retrieve or update data or metadata. At step 704, the cloud service agent transmits a request to discovery agent 150 for an authentication token. The request for an authentication token specifies the name of a role, e.g., “role-name-1.” At step 706, discovery agent 150 checks SDDC privilege mappings 152 to determine if the cloud service agent is authorized for the requested role.

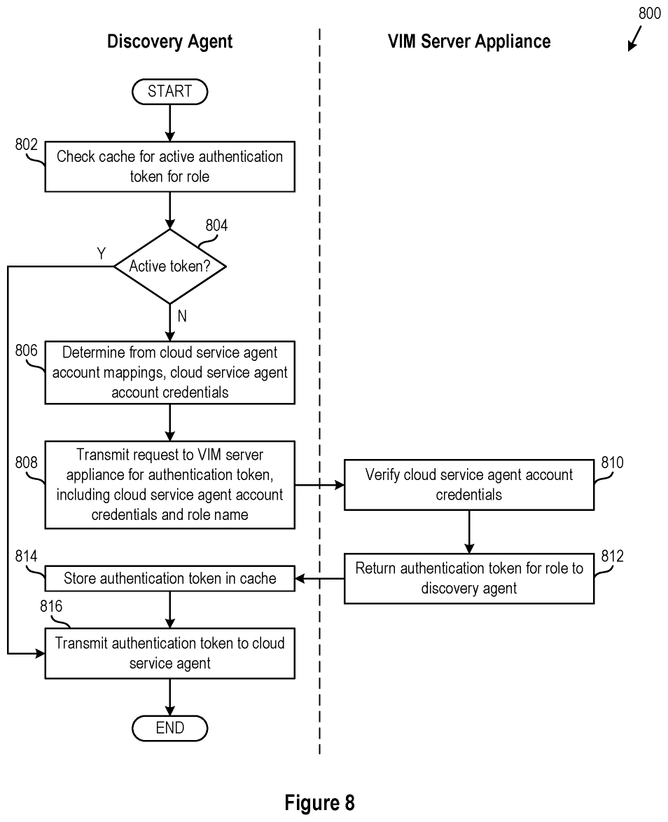

At step 708, if the cloud service agent is authorized, method 700 moves to step 710, and discovery agent 150 acquires an authentication token for the requested role, as discussed further below in conjunction with FIG. 8. Discovery agent 150 also returns the authentication token to the cloud service agent. At step 712, the cloud service agent accesses VIM server appliance 122 using the authentication token acquired from discovery agent 150 to retrieve or update specified data or metadata of VIM server appliance 122. After step 712, method 700 ends, and upon verifying that the request is within the scope of the authentication token, VIM server appliance 122 performs the requested access. VIM server appliance 122 then transmits the results of the operation to the cloud service agent.

Returning to step 708, if the cloud service agent is not authorized for the requested role, method 700 moves to step 714. At step 714, discovery agent 150 reports to the cloud service agent that the requested access to VIM server appliance 122 is denied. After step 714, method 700 ends. FIG. 7 illustrates a specific sequence in which the cloud service agent detects a request from cloud service 112 to perform an operation, and then the cloud service agent requests an authentication token to be used for issuing the command to VIM server appliance 122. However, it should be noted that the cloud service agent may also independently determine to issue a command to VIM server appliance 122, i.e., without an operation first being requested by cloud service 112.

FIG. 8 is a flow diagram of steps performed by discovery agent 150 and VIM server appliance 122 to carry out a method 800 of acquiring an authentication token for a cloud service agent to authenticate with VIM server appliance 122, according to an embodiment. At step 802, discovery agent 150 checks cache 158 to determine if there is an active authentication token for a requested role, i.e., if there is such an authentication token for which the TTL has not lapsed. At step 804, if discovery agent 150 find an active authentication token, method 800 moves to step 816. Otherwise, method 800 moves to step 806.

At step 806, discovery agent 150 determines from cloud service agent account mappings 154, the credentials for the cloud service agent's account with VIM server appliance 122. At step 808, discovery agent 150 transmits a request to VIM server appliance 122 for the authentication token that is scoped to the requested role. The request includes the cloud service agent account credentials determined at step 806 and the role name of the requested role. At step 810, VIM server appliance 122 verifies the cloud service agent account credentials to determine that the cloud service agent account is linked to the requested role.

At step 812, VIM server appliance 122 returns an authentication token scoped to the requested role, to discovery agent 150. At step 814, discovery agent 150 stores the authentication token in cache 158. At step 816, discovery agent 150 transmits an authentication token to the cloud service agent, which was either found in cache 158 at step 802 or returned by VIM server appliance 122 at step 812. After step 816, method 800 ends.

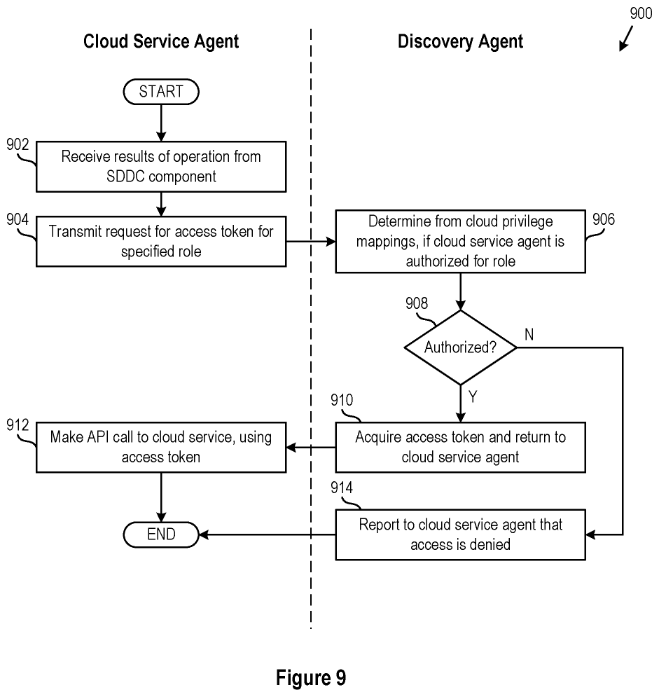

FIG. 9 is a flow diagram of steps performed by a cloud service agent of agent platform appliance 140 and discovery agent 150 to carry out a method 900 of making an API call to cloud service 112, according to an embodiment. At step 902, the cloud service agent receives results of an operation performed by VIM server appliance 122. At step 904, the cloud service agent transmits a request to discovery agent 150 for an access token. The request for an access token specifies the name of a role, e.g., “role-name-4.” At step 906, discovery agent 150 checks cloud privilege mappings 156 to determine if the cloud service agent is authorized for the requested role.

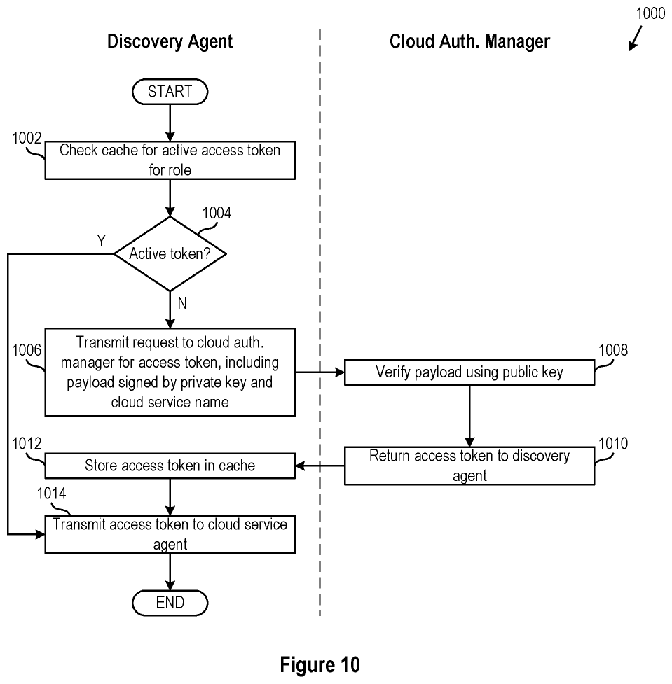

At step 908, if the cloud service agent is authorized, method 900 moves to step 910, and discovery agent 150 acquires an access token for the requested role, as discussed further below in conjunction with FIG. 10. Discovery agent 150 also returns the access token to the cloud service agent. At step 912, the cloud service agent makes an API call to cloud service 112 to report the results, using the access token to authenticate that the cloud service agent is authorized for the access. After step 912, method 900 ends.

Returning to step 908, if the cloud service agent is not authorized for the requested role, method 900 moves to step 914. At step 914, discovery agent 150 reports to the cloud service agent that the requested access to cloud service 112 is denied. After step 914, method 900 ends. FIG. 9 illustrates a specific sequence in which the cloud service agent receives results from VIM server appliance 122, and then the cloud service agent requests an access token to be used for making an API call to cloud service 112. However, it should be noted that the cloud service agent may also determine to make an API call to cloud service 112 without first receiving results from VIM server appliance 122. The cloud service agent may make an API call for separate reasons beyond reporting results of operations performed by VIM server appliance 122.

FIG. 10 is a flow diagram of steps performed by discovery agent 150 and cloud authentication service 116 to carry out a method 1000 of acquiring an access token for authenticating with cloud service 112, according to an embodiment. At step 1002, discovery agent 150 checks cache 158 to determine if there is an active access token for a requested role, i.e., if there is such an access token for which the TTL has not lapsed. At step 1004, if discovery agent 150 find an active access token, method 1000 moves to step 1014. Otherwise, method 1000 moves to step 1006.

At step 1006, discovery agent 150 transmits a request to cloud authentication service 116 for an access token that is scoped to the requested role. The request includes a payload signed by a private key of the tenant and the name of the requested role. At step 1008, cloud authentication service 116 verifies the payload using a public key of the tenant to determine that the request is from discovery agent 150. At step 1010, cloud authentication service 116 returns an access token scoped to the requested role to discovery agent 150. At step 1012, discovery agent 150 stores the access token in cache 158. At step 1014, discovery agent 150 transmits an access token to the cloud service agent, which was either found in cache 158 at step 1002 or returned by cloud authentication service 116 at step 1010. After step 1014, method 1000 ends.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are hard disk drives (HDDs), SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of controlling access to components of a software-defined data center (SDDC) in a hybrid environment, the hybrid environment including a cloud platform from which cloud services are delivered to the SDDC through agents deployed on an agent platform appliance which is connected to a management network of the SDDC, the method comprising:
transmitting to a first component of the SDDC, a request to create a first account for accessing the first component of the SDDC by a first agent, which is one of the agents deployed on the agent platform appliance;
in response to the first agent requesting access to the first component of the SDDC, transmitting to the first component of the SDDC, credentials associated with the first account and a request for a first authentication token that authorizes the access to the first component of the SDDC; and
upon receiving the first authentication token from the first component of the SDDC, transmitting the first authentication token to the first agent, wherein the first agent transmits to the first component of the SDDC, the first authentication token along with a first command that instructs the first component of the SDDC to perform an operation.

2. The method of claim 1, further comprising:
maintaining mappings indicating which privileges are assigned to which of a plurality of the agents deployed on the agent platform appliance; and
prior to the transmitting of the request for the first authentication token to the first component of the SDDC, determining from the mappings that the first agent is authorized to acquire the first authentication token.

3. The method of claim 2, wherein the first authentication token is scoped, by the first component of the SDDC, to a role that is associated with at least one of the privileges.

4. The method of claim 1, further comprising:
transmitting to a remote server, a request for an access token that authorizes access to a first cloud service of the cloud platform; and
upon receiving the access token from the remote server, transmitting the access token to the first agent, wherein the first agent transmits to the first cloud service, the access token along with results of the first component of the SDDC performing the operation.

5. The method of claim 4, further comprising:
maintaining mappings indicating which privileges are assigned to which of a plurality of the agents deployed on the agent platform appliance; and
prior to the transmitting of the request for the access token to the remote server, determining from the mappings that the first agent is authorized to acquire the access token.

6. The method of claim 1, further comprising:
after a creation of the first account by the first component of the SDDC, periodically transmitting to the first component of the SDDC, a request to update the credentials associated with the first account.

7. The method of claim 1, further comprising:
upon the receiving of the first authentication token from the first component of the SDDC, storing the first authentication token in a cache, wherein the first authentication token has a specified time-to-live (TTL) after which the first authentication token expires;
in response to the first agent again requesting access to the first component of the SDDC, retrieving the first authentication token from the first cache and transmitting the retrieved first authentication token to the first agent, wherein the first agent transmits to the first component of the SDDC, the first authentication token retrieved from the first cache along with a second command that instructs the first component of the SDDC to perform another operation; and
in response to the specified TTL elapsing, deleting the first authentication token from the cache.

8. The method of claim 1, further comprising:
transmitting to a second component of the SDDC, a request to create a second account for accessing the second component of the SDDC by a second agent, which is one of the agents deployed on the agent platform appliance;
in response to the second agent requesting access to the second component of the SDDC, transmitting to the second component of the SDDC, credentials associated with the second account and a request for a second authentication token that authorizes the access to the second component of the SDDC; and
upon receiving the second authentication token from the second component of the SDDC, transmitting the second authentication token to the second agent, wherein the second agent transmits to the second component of the SDDC, the second authentication token along with a second command that instructs the second component of the SDDC to perform another operation.

9. The method of claim 8, wherein the second agent executes in the agent platform appliance for a limited time, and the second account has a specified time-to-live (TTL) after which the second account expires, the method further comprising in response to the specified TTL elapsing, transmitting a request to the second component of the SDDC to delete the second account.

10. A non-transitory computer-readable medium comprising instructions that are executable in a computer system, wherein the instructions when executed cause the computer system to carry out a method of controlling access to components of a software-defined data center (SDDC) in a hybrid environment, the hybrid environment including a cloud platform from which cloud services are delivered to the SDDC through agents deployed on an agent platform appliance which is connected to a management network of the SDDC, the method comprising:
transmitting to a first component of the SDDC, a request to create a first account for accessing the first component of the SDDC by a first agent, which is one of the agents deployed on the agent platform appliance;
in response to the first agent requesting access to the first component of the SDDC, transmitting to the first component of the SDDC, credentials associated with the first account and a request for a first authentication token that authorizes the access to the first component of the SDDC; and
upon receiving the first authentication token from the first component of the SDDC, transmitting the first authentication token to the first agent, wherein the first agent transmits to the first component of the SDDC, the first authentication token along with a first command that instructs the first component of the SDDC to perform an operation.

11. The non-transitory computer-readable medium of claim 10, the method further comprising:
maintaining mappings indicating which privileges are assigned to which of a plurality of the agents deployed on the agent platform appliance; and
prior to the transmitting of the request for the first authentication token to the first component of the SDDC, determining from the mappings that the first agent is authorized to acquire the first authentication token.

12. The non-transitory computer-readable medium of claim 11, wherein the first authentication token is scoped, by the first component of the SDDC, to a role that is associated with at least one of the privileges.

13. The non-transitory computer-readable medium of claim 10, the method further comprising:
transmitting to a remote server, a request for an access token that authorizes access to a first cloud service of the cloud platform; and
upon receiving the access token from the remote server, transmitting the access token to the first agent, wherein the first agent transmits to the first cloud service, the access token along with results of the first component of the SDDC performing the operation.

14. The non-transitory computer-readable medium of claim 13, the method further comprising:
maintaining mappings indicating which privileges are assigned to which of a plurality of the agents deployed on the agent platform appliance; and
prior to the transmitting of the request for the access token to the remote server, determining from the mappings that the first agent is authorized to acquire the access token.

15. The non-transitory computer-readable medium of claim 10, the method further comprising:
after a creation of the first account by the first component of the SDDC, periodically transmitting to the first component of the SDDC, a request to update the credentials associated with the first account.

16. The non-transitory computer-readable medium of claim 10, the method further comprising:
upon the receiving of the first authentication token from the first component of the SDDC, storing the first authentication token in a cache, wherein the first authentication token has a specified time-to-live (TTL) after which the first authentication token expires;
in response to the first agent again requesting access to the first component of the SDDC, retrieving the first authentication token from the first cache and transmitting the retrieved first authentication token to the first agent, wherein the first agent transmits to the first component of the SDDC, the first authentication token retrieved from the first cache along with a second command that instructs the first component of the SDDC to perform another operation; and
in response to the specified TTL elapsing, deleting the first authentication token from the cache.

17. The non-transitory computer-readable medium of claim 10, the method further comprising:
transmitting to a second component of the SDDC, a request to create a second account for accessing the second component of the SDDC by a second agent, which is one of the agents deployed on the agent platform appliance;
in response to the second agent requesting access to the second component of the SDDC, transmitting to the second component of the SDDC, credentials associated with the second account and a request for a second authentication token that authorizes the access to the second component of the SDDC; and
upon receiving the second authentication token from the second component of the SDDC, transmitting the second authentication token to the second agent, wherein the second agent transmits to the second component of the SDDC, the second authentication token along with a second command that instructs the second component of the SDDC to perform another operation.

18. The non-transitory computer-readable medium of claim 17, wherein the second agent executes in the agent platform appliance for a limited time, and the second account has a specified time-to-live (TTL) after which the second account expires, the method further comprising:
in response to the specified TTL elapsing, transmitting a request to the second component of the SDDC to delete the second account.

19. A computer system comprising a plurality of servers, the plurality of servers including an agent platform appliance connected to a management network of a software-defined data center (SDDC), and the agent platform appliance including a plurality of agents deployed thereon, wherein the agents include a first agent that configured to:
transmit to a first component of the SDDC, a request to create a first account for accessing the first component of the SDDC by a second agent, which is one of the agents deployed on the agent platform appliance;
in response to the second agent requesting access to the first component of the SDDC, transmit to the first component of the SDDC, credentials associated with the first account and a request for a first authentication token that authorizes the access to the first component of the SDDC; and
upon receiving the first authentication token from the first component of the SDDC, transmit the first authentication token to the second agent, wherein the second agent transmits to the first component of the SDDC, the first authentication token along with a first command that instructs the first component of the SDDC to perform an operation.

20. The computer system of claim 19, wherein the first agent is further configured to:
maintain mappings indicating which privileges are assigned to which of a plurality of the agents deployed on the agent platform appliance, and
prior to the transmitting of the request for the first authentication token to the first component of the SDDC, determine from the mappings that the second agent is authorized to acquire the first authentication token.

21. The computer system of claim 20, wherein the first authentication token is scoped, by the first component of the SDDC, to a role that is associated with at least one of the privileges.

22. The computer system of claim 19, wherein the first agent is further configured to;
transmit to a remote server, a request for an access token that authorizes access to a first cloud service of the cloud platform; and
upon receiving the access token from the remote server, transmit the access token to the second agent, wherein the second agent transmits to the first cloud service, the access token along with results of the first component of the SDDC performing the operation.

23. The computer system of claim 22, wherein the first agent is further configured to:
maintain mappings indicating which privileges are assigned to which of a plurality of the agents deployed on the agent platform appliance; and
prior to the transmitting of the request for the access token to the remote server, determine from the mappings that the first agent is authorized to acquire the access token.

24. The computer system of claim 19, wherein the first agent is further configured to:
after a creation of the first account by the first component of the SDDC, periodically transmit to the first component of the SDDC, a request to update the credentials associated with the first account.

25. The computer system of claim 19, wherein the first agent is further configured to:
upon the receiving of the first authentication token from the first component of the SDDC, store the first authentication token in a cache, wherein the first authentication token has a specified time-to-live (TTL) after which the first authentication token expires;
in response to the second agent again requesting access to the first component of the SDDC, retrieve the first authentication token from the first cache and transmit the retrieved first authentication token to the second agent, wherein the second agent transmits to the first component of the SDDC, the first authentication token retrieved from the first cache along with a second command that instructs the first component of the SDDC to perform another operation, and
in response to the specified TTL elapsing, delete the first authentication token from the cache.

26. The computer system of claim 19, wherein the first agent is further configured to:
transmit to a second component of the SDDC, a request to create a second account for accessing the second component of the SDDC by a third agent, which is one of the agents deployed on the agent platform appliance;
in response to the third agent requesting access to the second component of the SDDC, transmit to the second component of the SDDC, credentials associated with the second account and a request for a second authentication token that authorizes the access to the second component of the SDDC, and
upon receiving the second authentication token from the second component of the SDDC, transmit the second authentication token to the third agent, wherein the third agent transmits to the second component of the SDDC, the second authentication token along with a second command that instructs the second component of the SDDC to perform another operation.

27. The computer system of claim 26, wherein the third agent executes in the agent platform appliance for a limited time, the second account has a specified time-to-live (TTL) after which the second account expires, and the first agent is further configured to:
in response to the specified TTL elapsing, transmit a request to the second component of the SDDC to delete the second account.
